(19) United States
(12) Patent Application Publication
(10) Pub. No.: US 2014/0061377 A1
(43) Pub. Date: Mar. 6, 2014

(54) Spear Tactical RFID Unmanned Aircraft System (UAS)

(71) Applicant: Donald Earl Smith, Xenia, OH (US)

(72) Inventor: Donald Earl Smith, Xenia, OH (US)

(21) Appl. No.: 13/682,816

(22) Filed: Nov. 21, 2012

Related U.S. Application Data
(62) Division of application No. 13/572,877, filed on Aug. 13, 2012.
(60) Provisional application No. 61/629,600, filed on Nov. 22, 2011.

(51) Int. Cl. B64F 1/02; B64F 1/06; G06K 7/10; B64F 1/04

(52) U.S. Cl. CPC B64F 1/02; B64F 1/04; B64F 1/06; G06K 7/10366
USPC 244/63; 340/10.1

(57) ABSTRACT

This disclosure relates generally to the field of unmanned aircraft systems (UAS), specifically to launch, fly and land unmanned aerial vehicles (UAV). This disclosure describes a system comprised of a UAV, a portable launch pad, a telescoping landing net and an integrated RFID system. This system provides a unique combination of UAV performance and payload capabilities with integrated Radio Frequency Identification Device (RFID) electronic systems capable of withstanding extreme weather conditions including high winds in remote locations.

### CROSS REFERENCE TO RELATED APPLICATIONS

This application incorporates by reference the U.S. non provisional patent application Ser. No. 13/572, 877 by Donald Smith, filed on Aug. 13, 2012, having the title, “Delta Wing Unmanned Aerial Vehicle (UAV) and Method of Manufacture of the Same” as if it were expressly set forth herein in its entirety.

This application claims the benefit of U.S. provisional patent application No. 61/629,600 by Donald Smith, filed Nov. 22, 2011, having the title, “SPEAR Tactical RFID Unmanned Aircraft System (UAS).”

### BACKGROUND

1. Field of the Disclosure

The present disclosure relates generally to the field of unmanned aircraft vehicles and systems to launch, navigate and land said vehicles.

2. Description of Related Art

While there are numerous unmanned aerial vehicles in use, there is a need for both a lightweight UAV and the means by which to launch, land and navigate said vehicles in remote locations and in challenging environmental conditions.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a nylon landing net with telescopic poles.

FIG. 2 shows a side view of a portable launching pad.

FIG. 3 shows a front view of a portable launching pad.

FIG. 4 shows an overhead view of portable launching pad rear stabilizer ground support with foot pedal release.

FIG. 5 shows a cross section view of the portable launching pad's main rail with launch shoe attached.

FIG. 6 shows a cross section view of the portable launching pad's main rail with joiners affixed.

### DETAILED DESCRIPTION OF THE EMBODIMENTS

In the previously filed cross-referenced application for the Delta Wing UAV (U.S. Ser. No. 13/572, 877), the inventors disclosed a lightweight unmanned aerial vehicle (UAV) capable of rapid assembly and de-assembly in remote locations and extended flight operations in remote, sometimes harsh environmental conditions, such as high winds and rain. The claimed UAV is capable of being hand-launched from any location and is capable of landing in almost any terrain, depending on its payload and the operational conditions under which it is being deployed.

The present disclosure of the unmanned aircraft system (UAS) presents a solution for launching, operating and landing UAVs when hand launching or landing on the ground is not an option. In one embodiment, a UAV incapable of landing on a traditional runway or one that contains highly sensitive payload can be landed in rugged or remote terrain using a telescoping landing net which provides a quickly deployable solution to land the UAV safely without contact with the ground. Furthermore, when a UAV is of a particular weight or the conditions are such that hand launching is not an option, a portable launch pad can be employed as part of the disclosed UAS to provide the necessary thrust to successfully launch the UAV. Two examples of such contrasting operator needs can be seen in considering a military UAV implementation and that of civilian scientific researchers. Operational conditions associated with a military operation may require only hand launching and landing on exposed ground due to tactical concerns, such as the ability to move quickly with little weight, quietly, with little chance of detection from a rugged remote location. In such situations, a launch pad, even a small one such as the one disclosed herein, or a landing net may not be practical or even prove a threat to the military operation. Whereas, a scientific research deployment of the UAV may have significantly different needs and capability. A non-tactical, civilian implementation may not have the concerns with extra equipment or the concerns with detection by an enemy. Furthermore, a civilian research operation may be a fixed location. Additionally, scientific experiments may have expensive UAV payloads; those which the operators may not want to risk to a traditional ground landing in favor of a landing net. The UAS embodiments disclosed herein provide the operator flexibility in the manner in which his UAV is launched and landed. Lastly, the disclosure provides even more flexibility and advantages to a diverse operator group in the use of a radio frequency identification device (RFID) active tags and RFID active tag readers to improve information collection and use capabilities of any UAV. Thus, the disclosed embodiments provide a lightweight, cost-efficient, system for launching, navigating and landing lightweight unmanned aerial vehicles in a potentially unlimited number of environments.

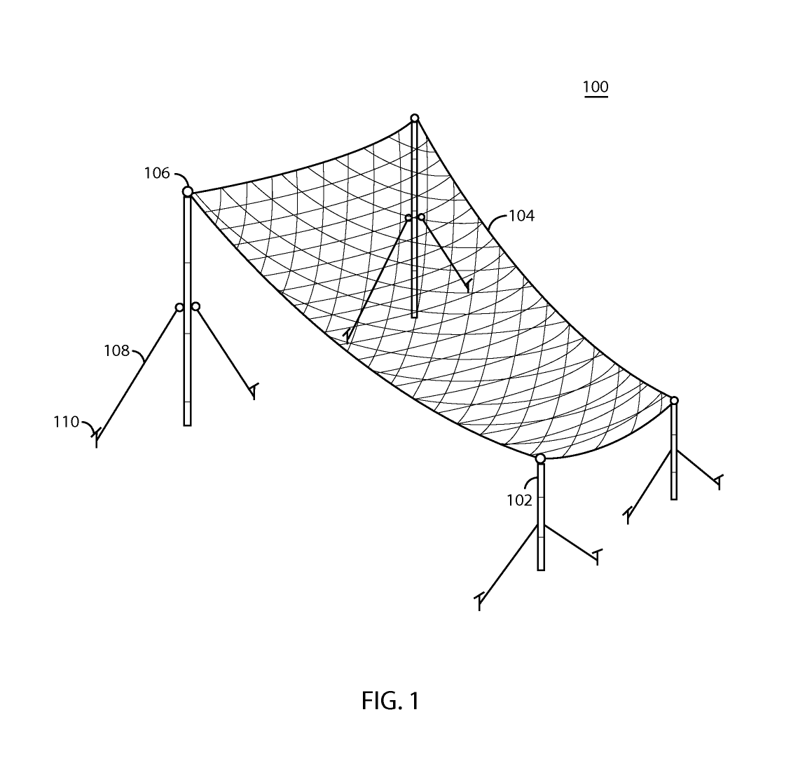

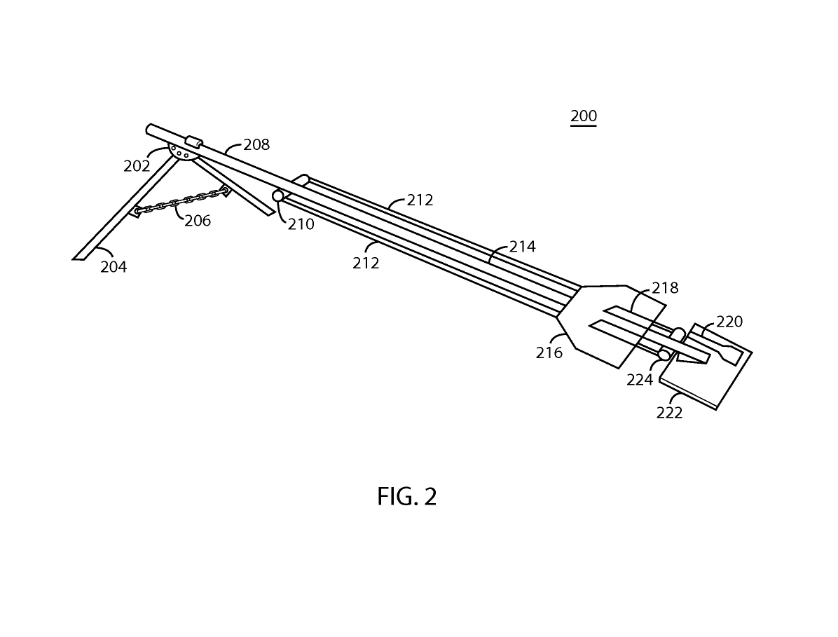

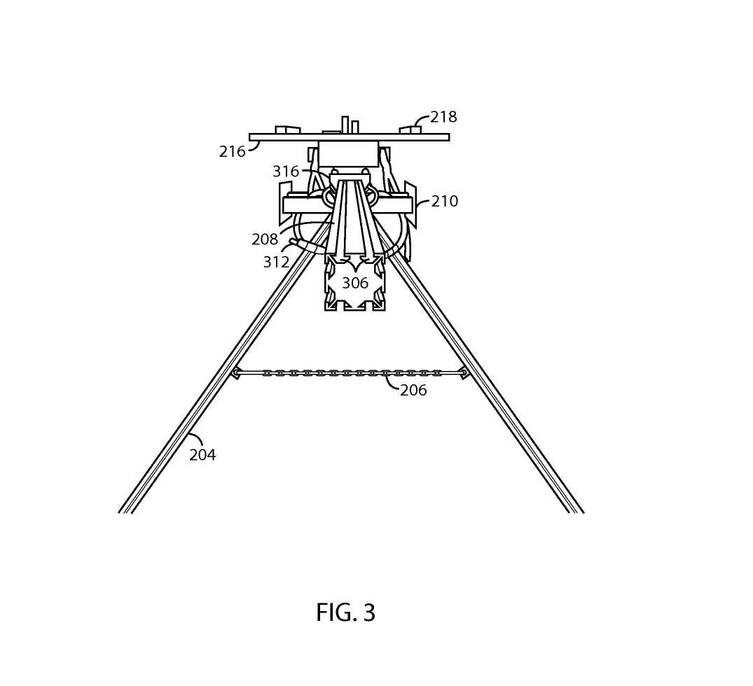

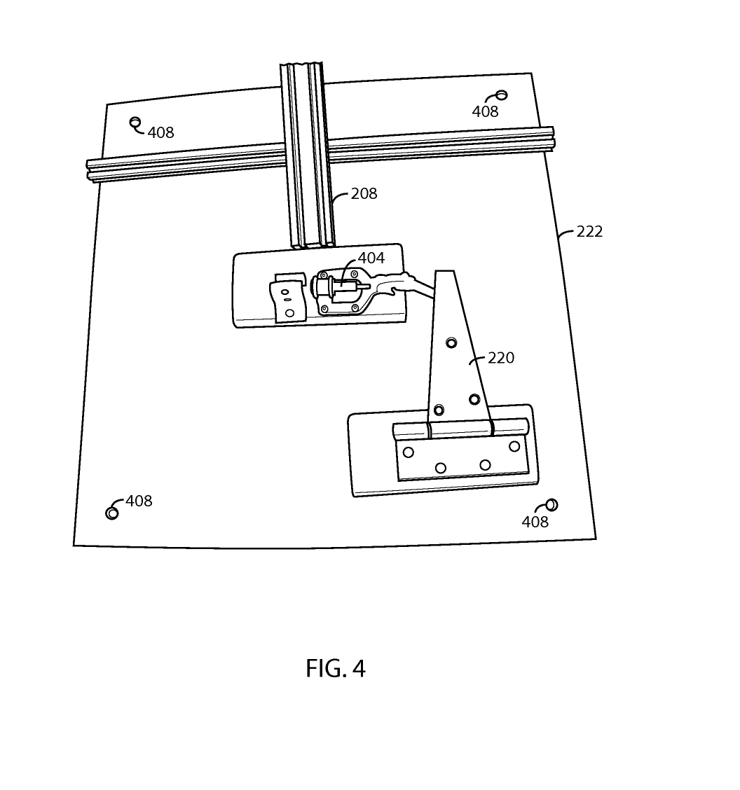

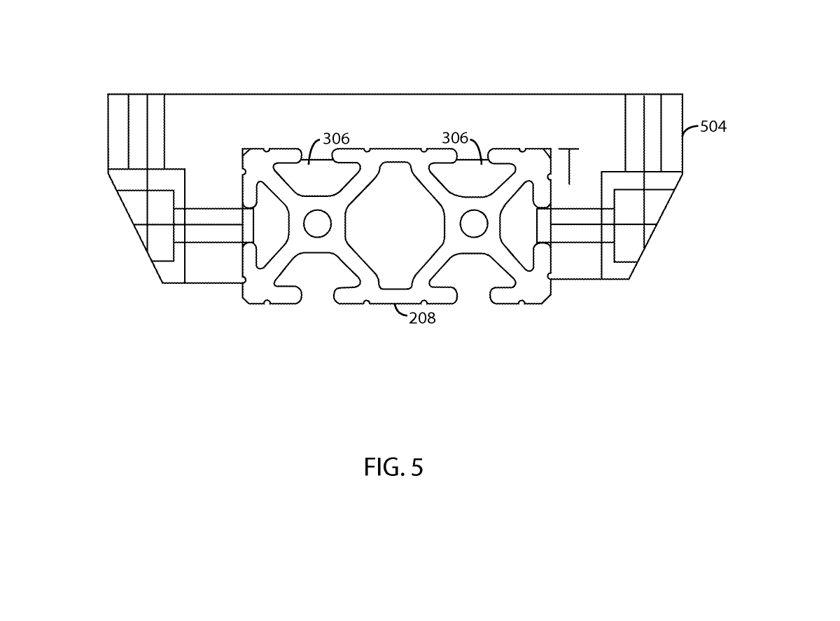

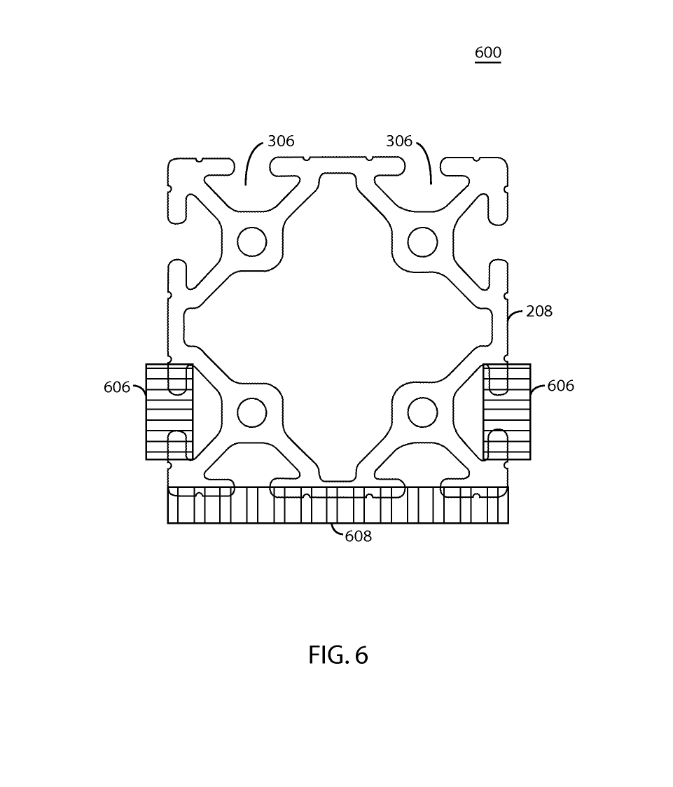

A review of the drawings provided herein will be helpful in understanding the UAS. FIG. 1 shows the telescoping landing net system for landing a UAV in varied terrain. FIGS. 2 and 3 show two views of the portable launch pad. FIG. 4 provides an overhead view of the portable launch pad's rear ground stabilizer support. FIG. 5 shows a cross section view of the portable launch pad's main rail and launch shoe. FIG. 6 shows a cross section view of the portable launch pad's two-piece main rail with joiners affixed.

Referring now to the drawings in more detail, FIG. 1 depicts a telescoping landing net system 100. In one embodiment, the telescoping net landing system's 100 dimensions are thirty feet by thirty feet (30′×30′). In its preferred embodiment, the net 104 is comprised of nylon barrier netting and measures fifteen feet in length by one foot, three quarter inches in width (15′×1′¾″). The netting is formed through twisted knotting of three-eighth inches (⅜″) in width. The twisted knotting composition provides the required flexibility and strength to withstand the impact of the UAV, while maintaining a low weight. The net's 104 spaces, or holes, can be of variable size depending on the size and weight of the UAV. In the preferred embodiment the net would have holes no larger than two inches (2″) and no smaller than one and three quarter inches (1¾″). In alternate embodiments, smaller holes may be desired to prevent snagging of UAV edges or antenna. In other embodiments, larger holes may be desired to better support the weight of the UAV. A person having ordinary skill in the art will appreciate the correlation between the size of the net 104 used and its corresponding hole sizes to provide optimum support for the UAV in use. The disclosed embodiment can support UAVs ranging in weight from four to twelve pounds and flying at an airspeed of thirty miles per hour (30 m.p.h.), or less, upon contact with the telescoping landing net system 100.

In one embodiment, the net 104 is supported by four (4) aluminum telescoping pole net supports 102, with the heights of each pole net support being adjustable. In one embodiment, the poles' height can be adjusted through the use of detent holes and buttons to adjust and lock the pole height. In another embodiment, the telescoping poles can be adjusted using holes and a sliding pin, tethered to the pole with steel wire. A person having ordinary skill in the art will understand many commercially available telescoping, or adjustable, poles may be used to provide this functionality to orient the net 104 as appropriate to collect the UAV in use. As presented in FIG. 1, the rear poles are adjusted to a greater height than the forward poles to provide a higher barrier for the landing UAV. Such an embodiment is commonly used with UAV's capable of landing with more horizontal direction than vertical. However, this is only one such embodiment and is presented for demonstration purposes only and should not be understood to be the sole embodiment of the telescoping landing net system.

The telescoping pole net supports 102 fit into the net 104 using eyelet net connectors 106. In one embodiment, each pole net support 102 is secured to the ground using two (2) all terrain stakes with supporting cords 108. In an alternate embodiment, the poles 102 can be secured to the terrain through the use of hard surface pole mounts, capable of being secured to a non-penetrable horizontal surface, such as steel or possibly some kinds of concrete.

The portable launch pad is designed for simplicity, portability, adaptability, and ease of use. The disclosed embodiment presents three novel characteristics that give the launch pad the exceptional flexibility that make it capable of implementation in many different environments. First, the portable launch pad can be quickly assembled and disassembled for portability and flexibility to enable the operator to quickly adjust to changing conditions or implementation of different missions. Secondly, the portable launch pad requires no external power source, as it generates all power from flexible tubing that can be adjusted for different launching power requirements. Thirdly, the launch pad provides directional launch capability for any UAV, as opposed to launching off the ground or from an operator's hand. This capability is especially critical when launching into high winds.

FIGS. 2 and 3 show the portable launch pad. FIG. 2 presents a side view of the portable launch pad 200, while FIG. 3 presents a front view of the portable launch pad 200.

Looking at FIG. 2, the adjustable launch pitch mechanism 202 enables the portable launch pad to be raised or lowered to the desired angle for launch. Additionally, two (2) folding stabilizer legs 204 are extended from the front of the portable launch pad 200. The folding stabilizer legs 204 serve to support the upper end of the main rail 208 and can also be adjusted to determine the angle the portable launch pad 200 attains. The stabilizer legs 204 can also remain attached to the main rail 208 when the portable launch pad 200 is disassembled for storage or transport. This feature of the stabilizer legs 204 attached to the main rail 208 permits rapid adjustment of the entire launch pad's 200 compass heading to allow launches directly into the wind or as otherwise required by the operator's mission or the type of UAV being launched. A support chain 206 connects the stabilizer legs 204 to prevent lateral over extension of the stabilizer legs 204.

Two roller band tension tubes are connected to the main rail 208. The forward roller band tension tube 210 is permanently attached and a rear roller band tension tube 224 is adjustable. Attached to, and extended from each roller band tension tube, are two (2) catapult bands 212. The launch pad mount 216 is connected to the main rail 208 with a sliding launch shoe. In its preferred embodiment, when the UAV is a Delta Wing UAV, the launch pad mount 216 has two UAV launch guides 218 installed on its topside. Attached to the rear of the main rail 208 is the rear stabilizer ground support 222 with a foot release 220.

Turning to FIG. 3, a front view of the portable launch pad 200 is presented. Again, the stabilizer legs 204 with support chain 206 are presented. The main rail 208 is presented with two (2) channels 306 presented on each of the main rail's 208 four (4) sides. The launch pad mount 216 with UAV launch guides 218 is likewise presented. The forward roller band tension tube 210 is presented. An adjustable brake slider 316 is attached to a predetermined location toward the forward end of the main rail 208. Two additional lengths of catapult band 312 are attached at the slider brake 316.

FIG. 4 shows an overhead view of the rear ground stabilizer support 222. The main rail 208 is bolted to the rear ground stabilizer support 222. At the rear end of the main rail 208 on the rear ground stabilizer support 222 is an eye-bolt 404 which is connected to the foot release 220 through a draw-bolt arrangement that permits the draw bolt to be extracted by a foot pedal to initiate the launch. In one embodiment, the rear ground stabilizer 222 has four (4) stake holes 408.

FIG. 5 presents a cross sectional view of the main rail 208 with the launch pad mount's underlying launch shoe 504, which is a double flange linear bearing and can slide up and down the main rail through connection to the main rail's 208 top two channels 306. In the preferred embodiment, the channels are one inch (1″) apart. The launch shoe 504 is affixed to the launch pad mount on the mount's underside using a conventional bolt and nut assembly.

FIG. 6 presents a cross sectional view of the main rail 208 which is comprised of two equal pieces, each measuring six foot (6′) in length in the preferred embodiment. Likewise, in the preferred embodiment, each half of the main rail 208 is comprised of a T-slotted aluminum extrusion, measuring two inches by two inches (2″×2″). However, alternate embodiments can include smaller or larger main rails to scale. The main rail's 208 two halves are joined together using two kinds of joiner plates, both of which are commercially available. Installed at the bottom of the main rail 208 is an eight-hole joiner plate 608. In one embodiment, the eight-hole joiner plate 608 measures four inches long by two inches wide (4″ L×2″ W). On each side of the main rail 208 and installed into the lower channel on either side of the main rail is a four-hole joiner plate 606. In one embodiment, the four-hole joiner plate 606 measures two inches by two inches (2″×2″). Both the four-hole and eight-hole joiner plates are common to the art and commercially available. A person having ordinary skill in the art would appreciate the manner in which such joiner plates are used and affixed to rigid aluminum extrusions, such as the two-piece main rail 208 disclosed here.

The manner of operation for the portable launch pad 200 shall now be discussed. In its preferred embodiment, the Delta Wing UAV of the cross-referenced non provisional application is placed upon the launch pad mount 216 using the UAV launch guides 218. When ready for launch, the UAV's motor is running and ready to power the UAV in flight once launched from the portable launch pad 200. The motive power for the portable launch pad 200 is generated from the two (2) catapult bands 212 comprised of mandrel-drawn surgical tubing stretched from the front of the launch shoe 504 located under the launch pad mount 216, around the forward roller band tension tube 210 and back to the rear roller band tension tube 224 fastened to the rear of the main rail 208. The force input to the launch shoe 504 from the catapult bands 212 can be adjusted by moving the rear roller band tension tube 224 either forward or aft on the main rail 208, thus changing the stretched length of the catapult bands 212. For example, more power may be required to launch a UAV of greater weight than that of a lighter UAV. By adjusting the rear roller band tension tube 224 accordingly, more or less power can be transferred to the UAV upon launch. The launch mount 216 is manually pulled by the operator to the aft portion of the main rail and the launch shoe 504 is locked to the rear stabilizer ground support 222 by engaging the eye-bolt 404.

When ready to launch the UAV, the operator depresses the foot release 220, which disengages the eye-bolt 404, thus releasing the launch shoe 504. Once the launch shoe 504 and launch pad mount 216 are freed from the rear ground stabilizer support 222, the force created by the contraction of the large catapult bands 212 pulls the launch shoe 504 forward, up the main rail 208. As shown in FIG. 3, the launch shoe 504 is retained on the rail at the end of a launch “stroke” by the brake slider 316 attached to a smaller length of tubing 312. This tubing 312 is looped around the forward roller band tension tube 210 located about two feet (2′) from the upper end of the main rail 208 in the preferred embodiment.

When the launch shoe 504 is driven up toward the forward end of the main rail 208, the launch shoe 504 contacts the brake slider 316 just as the launch shoe 504 passes the forward roller band tension tube 210. The combination of the large catapult bands 212 being stretched and the short tubing 312 being stretched by the brake slider 316 brings the launch shoe 504 to a halt before reaching the end of the main rail 208, launching the UAV into the air at the angle established by the placement of the stabilizer legs 204 and launch pitch mechanism 202. Once in the air, the UAV flies under its own motor power.

Another feature of the portable launch pad that adds to its flexibility is found in the rear ground stabilizer support 220. The support 220 attached to the rear of the main rail 208 serves as the only anchor point for the portable launch pad. When more support is desired and there is not a need to adjust the launch direction, the rear ground stabilizer support 220 can be staked vertically into the ground through each of its four (4) stake holes 408 using commercially available steel or plastic stakes. Or, in another embodiment, the launch pad 200 can remain unstaked, thus providing the operator the ability to quickly re-orient the launch pad into the wind or in another direction.

Lastly, the disclosed UAS provides enhanced functionality through the use of commercially available RFID active tag reader and active tags, which include a high-powered antenna and interface. In the cross-referenced application for the Delta Wing UAV, and in the preferred embodiment of this disclosure in which the UAV used in the claimed UAS is a Delta Wing UAV, this RFID active tag reader is located next to the auto pilot mechanism in the internal RFID navigation chamber located near the center internal storage chamber of Spear's Delta Wing UAV. The RFID navigation chamber is located behind a magnetic cargo door on the topside of the UAV. In any other UAV embodiment, the RFID active tag reader and antenna can be located wherever practical. For the rest of this written description, the preferred embodiment of the UAS using the Delta Wing UAV will be used for purposes of disclosing the RFID capabilities of the UAS.

The RFID active tag reader contains a high-powered gain antenna. This antenna is located in the same navigation chamber compartment of the Delta Wing UAV facing downward to the ground with a small penetration to expose the antenna to the exterior of the UAV. The RFID active tag reader is capable of reading data related to position, sensor readings, outputs or biometric status from active RFID tags attached to various ground-based items in several embodiments including, but not limited to, articles, devices or people that are stationary or in transit. The onboard reader communicates with the active tags using a variable packet length protocol. The standard protocol IEEE 802.15.4 is used, which is an industry standard. In one embodiment, the data from these tags can be stored for operator use upon interrogation or real-time download from the onboard RFID airborne reader. The RFID has several characteristics that make it suitable for the novel application presented here in the UAS.

Most RFID tags are passive devices with no power source. Such passive tags do not emit radio waves, rather only reflect or retransmit waves that strike them when irradiated by a reader device. This results in extremely short range capability, usually less than 10 feet. This usage also requires low frequency for efficiency. The information extracted from the tag is usually only an identification number and a control bit for theft prevention.

The disclosed embodiment of this RFID tag reader is an active emitter with an onboard power source. This allows the device to use a much higher frequency for communication. The band chosen for communication is the same as wireless fidelity (WIFI) and many commercial applications, however most RFID readers currently in use do not operate on such frequencies. The benefit of such specialized use of this frequency is improved sensitivity for the reader and bi-directional communication from the active tags. Active tags can thus accept impulses sent from the UAV and return them to the plane, providing the disclosed UAS superior capability over passive tag and reader implementation. The design of the active tag utilizes a small microprocessor, which makes added capabilities easy to implement. Such a tag not only responds with it's identity, but can act as a data collector for sensors attached to it, passing the stored data to the UAV's airborne reader upon interrogation. Furthermore, the frequency used (2.452-2.459 GHz MHz) allows utilization of commercial off the shelf (COTS) antennas and amplifiers in the airborne (reception end) unit for much longer range, a significant improvement over technologies currently used in the field of unmanned aerial vehicles. In some experiments, a distance of one mile has been achieved for such communications.

The usual mode of operation for an active tag system is to program the tag to “listen” for a reader interrogation request only at certain times. It also listens for sensor data and stores that data only at certain time intervals. This embodiment of an active tag system in the disclosed UAS permits very long operating times with small batteries as power sources. Another unique attribute of this tag system is the ability for the reader to reprogram the tag for different timing intervals via the radio link. No physical connection is required for this reprogramming. This feature disclosed in this embodiment gives dynamic control of the tags response times.

The various embodiments of the systems, as described herein, may be implemented in the materials described, as well as hardware, software, firmware, or a combination thereof. Although exemplary embodiments have been shown and described, it will be clear to those of ordinary skill in the art that a number of changes, modifications, or alterations to the disclosure as described may be made. All such changes, modifications, and alterations should therefore be seen as within the scope of the disclosure.

Any process descriptions or blocks in flow charts should be understood as representing modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure.

Although exemplary embodiments have been shown and described, it will be clear to those of ordinary skill in the art that a number of changes, modifications, or alterations to the disclosure as described may be made. All such changes, modifications, and alterations should therefore be seen as within the scope of the disclosure.

What is claimed is:

1. An unmanned aircraft system comprising:
a portable launch pad for launching unmanned aerial vehicles;
a landing net system with telescoping net support poles;
an unmanned aerial vehicle (UAV);
and a radio frequency identification device (RFID) system comprising active RFID tags, a UAV-based onboard active RFID tag reader and high powered gain antenna.

2. The unmanned aircraft system of system of claim 1, the telescoping net support poles having hard surface pole mounts for affixing said telescoping net support poles to the ground.

3. A portable launch pad for launching unmanned aerial vehicles comprising:
two forward stabilizer legs;
a main rail comprising joined parts with exposed channels attached to said stabilizer legs;
a launch pad mount for supporting and moving an unmanned aerial vehicle along said main rail;
a sliding launch shoe assembly attached to said launch pad mount with adjustable attachments to said main rail via said channels;
two rubber catapult bands attached to said sliding launch shoe and extended around two sets of roller band tension tubes which are adjustable to variable distances from one another;
a slide brake attached to the front of said main rail in advance of the forward set of roller band tension tubes;
and a rear ground stabilizer support plate with foot pedal release.

5. The portable launch pad of claim 3, the main rail comprising joined T-slotted aluminum extrusions of sides of equal length with eight exposed channels.

6. The portable launch pad of claim 3, the main rail's parts each connected with two (2) four hole joiner plates and one (1) eight hole joiner plate.

7. The portable launch pad of claim 3, the sliding launch shoe assembly being a double flange linear bearing.

8. The portable launch pad of claim 3, the slide brake being adjustable in location on said main rail.

9. The portable launch pad of claim 3, the rubber catapult bands adjusted in length by moving the rear roller band tension tube forward or aft along the main rail.

10. An unmanned aerial vehicle RFID system for in-flight bi-directional information transmission via wireless fidelity (WIFI) comprising:
active RFID tags;
a UAV-based onboard reader of said active RFID tags;
a UAV-based onboard high powered antenna;
and a UAV-based onboard power source for the RFID reader and antenna.

11. The unmanned aerial vehicle RFID system of claim 10, the active tags capable of receiving and sending information to the UAV-based onboard active tag reader.

12. The unmanned aerial vehicle RFID system of claim 10, the antenna comprising an amplifier for extended range communications.

13. The unmanned aerial vehicle RFID system of claim 10, the reader capable of in-flight reprogramming of active RFID tags.

14. The unmanned aerial vehicle RFID system of claim 10, the ground-based active RFID tags containing batteries and microprocessors.

15. The unmanned aerial vehicle RFID system of claim 10, the active RFID tags affixed to stationary, ground-based objects.

16. The unmanned aerial vehicle RFID system of claim 10, the active RFID tags affixed to individual personnel or vehicles.
